(19) United States
(12) Patent Application Publication
(10) Pub. No.: US 2026/0180199 A1
(43) Pub. Date: Jun. 25, 2026

(54) ARTICULATED FOLDING RIB REFLECTOR WITH FACET BREAKERS

(71) Applicant: UMBRA LAB, INC., Santa Barbara, CA (US)

(72) Inventors: Michael Bik, Santa Barbara, CA (US); Gabe Dominocielo, Santa Barbara, CA (US); David Langan, Santa Barbara, CA (US)

(21) Appl. No.: 18/990,960

(22) Filed: Dec. 20, 2024

(51) Int. Cl. H01Q 15/16

(52) U.S. Cl. CPC H01Q 15/161

(57) ABSTRACT

A reflector assembly includes a central hub; ribs coupled to the central hub that are configured to move between a stowed configuration and a deployed configuration; tensioner elements coupled to the ribs and that are configured to move between a stowed configuration and a deployed configuration; a flexible reflective material attached to the ribs and that includes facets in which each facet is between two adjacent ribs; facet breakers connected to the facets of the flexible reflective material; and at least one tensile element coupling the tensioner elements to the facet breakers. A first facet breaker is connected to a first facet, a first tensioner element is coupled to a first rib and to the first facet breaker, and a second tensioner element is coupled to a second rib and to the first facet breaker.

### BACKGROUND

### 1. Field

The present disclosure relates generally to electromagnetic radiation reflectors configured to function as large apertures for antennas.

2. Description of Related Art

Reflectors for focusing electromagnetic radiation are installed on a variety of platforms including spacecraft, aircraft, ground mobile vehicles, and fixed ground installations. They are often employed as a component in radio frequency and microwave antenna systems supporting varied applications including, for example, radio astronomy, communications and radar. As is known to a person of ordinary skill in the art, antennas which employ reflectors with large aperture areas are desirable because increasing aperture area improves antenna directivity and gain. Further, antennas incorporating reflectors are the commonly used in many applications, especially applications involving spacecraft, due to their lightweight, efficiency and broadband performance.

A parabolic reflector is a commonly used reflector in which the reflective surface closely approximates a section of a paraboloid. The surface is generated by revolving a parabola, or the section of a parabola, about an axis. An ideal parabolic reflector will focus an incoming plane wave, traveling along the axis of revolution, to a single point, which is referred to as the focal point. In addition to surfaces which substantially approximate a section of a circular paraboloid surface, other surfaces are known to be useful for focusing energy, for example, sections of circular spheroid surfaces and sections of circular hyperboloid surfaces.

Optimum focusing of incident collimated radiation to a point or small diameter circular spot is achieved when the curved surface has a paraboloidal shape. However, the shape of the curved surface may deviate from the paraboloid due to inaccuracies in the manufacturing process, design decisions based on economic consideration, or for other reasons. The shape of the curved surface may also deviate from a paraboloid if the radiation is to be concentrated on an area having an outline other than that of a small diameter circular spot (e.g., if microwave radiation is to be concentrated on an area approximating the outline of a continent).

Reflector surfaces are approximations of ideal surfaces and deviate somewhat relative to these ideal surfaces due to limitations in the design and manufacturing of the reflector. To minimize the radiation pattern error, the deviation from the ideal surface must be limited. The allowable level of deviation may be related to the wavelength of the electromagnetic energy and the desired accuracy of the radiation pattern. The root mean square (RMS) error of the true surface relative to the ideal surface along a unit vector normal to the ideal surface is often limited to 1/10 of the wavelength. At higher frequencies the wavelength is decreased, and therefore the allowable RMS error also decreases.

Satellite technologies are often required to be sufficiently robust to withstand the rigors of the space environment, to have low mass, and to be reliable. They must also be devised to reside within the limited volume available to contain the spacecraft and its components when transitioning from the Earth to space, and to survive the environmental rigors of this ascent to space. Often this volume is not sufficient to contain the technology when configured in the operational state required of it once in space. Furthermore, the dynamic loads applied during the ascent often exceed the strength of the technology in the operational state. In these cases, it is necessary for the technology to be configured in one state during the ascent to space, in which it conforms to the available volume and has sufficient strength to resist the forces applied during the ascent, and then to transition to another state in which the technology can perform the intended operational function. The former state in which the technology is configured for the ascent to space is commonly referred to as the stowed state, and the latter state in which the technology fulfills the intended operational function is commonly referred to as the deployed state.

It is believed that future space missions will require reflectors with large deployed areas, in which their overall mass is minimized, and in which the stowed volume is compatible with the volumes available to microsatellites of 100 kg or less and satellites utilizing small launch vehicles or rideshare solutions for access to space. Parabolic reflectors, with deployed diameters between 2 and 20 meters, and areal densities of 1 kg/m² or less are envisioned. Volume constraints represented by a cuboid with dimensions of 24 x 24 x 36, and mass constraints of 100 kg or less are typical of economical solutions for placing a satellite or spacecraft in orbit.

When manufacturing a large aperture reflector antenna for space, consideration must be made for sources of error, including, for example, the coefficient of thermal expansion for the selected materials, on-orbit temperatures and temperature gradients, material changes due to the vacuum and radiation environment, and deflections which alter measured data while testing on the ground due to orientation and gravity. Often ground support equipment is required to support large structures intended for space, during fabrication and testing on the ground. In the case of reflector antennas, this ground support equipment may need to be devised to support testing of the electromagnetic radiation pattern produced by the reflector surface or to support measurement of the reflector surface profile in a manner that provides meaningful insight into the reflector performance when it is in the space environment.

A variety of reflector antenna designs exist for focusing electromagnetic energy. However, many conventional antennas are not configured to provide both a large aperture and small stowed antenna volume. Additionally, some conventional antennas utilize complex mechanisms to deploy the reflector and support the reflector in the deployed configuration, such as standoffs and a series of drop cords supported by tension beams. The manufacturing and testing of these complex conventional antennas is often hampered by the difficulties associated with adjusting the length of the drop cords to control the accuracy of the surface profile of the flexible reflective material which constitutes the reflective surface.

Additionally, conventional reflector antennas include a variety of different methods to prevent the flexible reflective material from becoming entangled or bound to portions of the structure before or during deployment, which might otherwise prevent full deployment of the reflector, damage the structure, and/or tear or otherwise damage the flexible reflective material and thereby degrade the precision of the reflector with regards to the focusing of electromagnetic energy. Some conventional mechanisms for deploying the reflector include rotary electromechanical actuators, linear electromechanical actuators translated to rotary motion through linkages, cams, cables, pulleys, and/or screws, pneumatic actuators, and strain energy devices such as springs.

The above information disclosed in this Background section is only for enhancement of understanding of the background of the invention and therefore it may contain information that does not constitute prior art.

### SUMMARY

The present disclosure is directed to various embodiments of a reflector assembly. In one embodiment, the reflector assembly includes a central hub; ribs coupled to the central hub that are each configured to move between a stowed configuration and a deployed configuration; tensioner elements coupled to the ribs and that are configured to move between a stowed configuration and a deployed configuration; a flexible reflective material attached to the ribs and that includes facets, each of which are being two adjacent ribs; facet breakers connected to the facets of the flexible reflective material; and at least one tensile element coupling the tensioner elements to the facet breakers. A first facet breaker is connected to a first facet, a first tensioner element is coupled to a first rib and to the first facet breaker, and a second tensioner element is coupled to a second rib and to the first facet breaker.

The first facet breaker may be substantially centered between the first rib and the second rib.

The first facet breaker may be substantially oriented radially toward the central hub when the reflector assembly is in the deployed position.

The first facet breaker may be shorter than each of the first rib and the second rib.

The first facet breaker may have a length in a range from approximately 25% to approximately 50% of a length of each of the first rib and the second rib.

Each rib may include a root rib segment rotatably coupled to the central hub by a first hinge, at least one intermediate rib segment having a proximal end rotatably coupled to a distal end of the root rib segment by a second hinge, and a tip rib segment having a proximal end rotatably coupled to a distal end of the at least one intermediate rib segment by a third hinge.

The root rib segment may be configured to rotate in a first direction about a first axis away from a central axis of the central hub as the reflector assembly moves into the deployed configuration. The at least one intermediate rib segment may be configured to rotate in the first direction about a second axis substantially parallel to the first axis as the reflector assembly moves into the deployed configuration. The tip rib segment may be configured to rotate in the first direction about a third axis substantially parallel to the second axis as the reflector assembly moves into the deployed configuration.

Each of the tensioner elements may be configured to rotate about a fourth axis substantially parallel to the third axis as the reflector assembly moves into the deployed configuration.

Each of the facet breakers may be a secondary rib having a curved upper surface following a substantially parabolic profile.

The secondary rib may include openings to reduce mass.

The secondary rib may taper from a thickest intermediate portion toward a thinner distal end, and from the thickest intermediate portion toward a thinner proximal end.

The at least one tensile element may be a single continuous tensile element.

The at least one tensile element may include two or more discrete tensile segments.

The flexible reflective material, the ribs, and the facet breakers may together form a reflective surface with a substantially paraboloidal surface profile configured to focus electromagnetic energy when the reflector assembly is in the deployed position.

The reflector assembly may include a flexible net coupled to the flexible reflective material.

The number of ribs may be in a range from twenty-four to seventy-two.

The present disclosure also relates to a method of operating a deployable reflector assembly including a central hub, ribs coupled to the central hub, a flexible reflective material attached to the ribs, facet breakers coupled to the flexible reflective material, tensioner elements coupled to the ribs, and at least one tensile element coupling the tensioner elements to the facet breakers. In one embodiment, the method includes moving each of the ribs from a stowed configuration to a deployed configuration, and moving each of the tensioner elements from a stowed configuration to a deployed configuration.

Each rib of the ribs may include a root rib segment rotatably coupled to the central hub, an intermediate rib segment rotatably coupled to the root rib segment, and a tip rib segment rotatably coupled to the intermediate rib segment, and moving the ribs from the stowed configuration to the deployed configuration may include rotating, in a first direction away from a central axis of the central hub, the root rib segment of each rib relative to the central hub; rotating, in the first direction, the intermediate rib segment of each rib relative to the root rib segment after rotating the root rib segment; and rotating, in the first direction, the tip rib segment of each rib relative to the intermediate rib segment after rotating the intermediate rib segment.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a side view of a parabolic reflector according to one embodiment of the present disclosure focusing energy from a plane wave to a focal point located near to an antenna feed;

FIGS. 2A-2B are a top view and a side view, respectively, of a reflector in a stowed position according to one embodiment of the present disclosure;

FIGS. 3A-3F are a perspective view, an exploded perspective view, a top view, a side view, a detail perspective view, and a detail side view, respectively, of a reflector in a deployed position according to one embodiment of the present disclosure;

FIG. 4 is a side view of a facet breaker according to one embodiment of the present disclosure;

FIGS. 5A-5B are plots depicting a radiation pattern reflecting off a reflector according to one embodiment of the present disclosure; and

FIGS. 6A-6C are graphs depicting a signal reflected off a reflector having an ideal paraboloid shape, a related art reflector having ribs, and a reflector having ribs and facet breakers, respectively.

### DETAILED DESCRIPTION

The present disclosure is directed to various embodiments of a parabolic antenna reflector for focusing electromagnetic radiation. The reflector includes a flexible reflective material, a plurality of ribs supporting the flexible reflective material, and a plurality of facet breakers connected to the flexible reflective material between adjacent ribs. The facet breakers are configured to provide supplemental support for the flexible reflective material and thereby improve the approximation of a paraboloidal surface section formed by the flexible reflective material, which improves the gain, directivity, and efficiency of any antenna system employing the reflector. Additionally, by utilizing the facet breakers, rather than increasing the number of ribs, the reflector is configured to improve the approximation of an ideal surface section formed by the flexible reflective material without increasing the mass of the reflector associated with the additional ribs. In one or more embodiments, the facet breakers may be provided only at or proximate to the extent of the reflector where the flexible reflective material tends to deviate from a parabolic shape due to the spacing between adjacent ribs being the greatest at the extent.

The terminology utilized herein is for the purpose of describing particular embodiments only and is not intended to be limiting of the present disclosure. As utilized herein, the singular forms “a”, “an” and “the” are intended to include the plural forms as well, unless the context clearly indicates otherwise. As utilized herein, the term “and/or” includes any and all combinations of one or more of the associated listed items.

It will be understood that, although the terms “first”, “second”, “third”, etc., may be utilized herein to describe one or more suitable elements, components, regions, and/or sections, these elements, components, regions, and/or sections should not be limited by these terms. These terms are only utilized to distinguish one element, component, region, layer or section from another element, component, region, layer or section. Thus, a first element, component, region, or section discussed could be termed a second element, component, region, or section, without departing from the spirit and scope of the present disclosure.

It will be understood that when an element is referred to as being “on”, “connected to”, “coupled to”, or “adjacent to” another element, it can be directly on, connected to, coupled to, or adjacent to the other element, or one or more intervening element(s) may be present. In contrast, when an element is referred to as being “directly on,” “directly connected to”, “directly coupled to”, or “immediately adjacent to” another element, there are no intervening elements present.

As utilized herein, the term "substantially" and similar terms are utilized as terms of approximation and not as terms of degree, and are intended to account for the inherent deviations in measured or calculated values that would be recognized by those of ordinary skill in the art. Also, the terms “about,” “approximately,” and similar terms, when utilized herein in connection with a numerical value or a numerical range, are inclusive of the stated value and refer to within an acceptable range of deviation for the particular value as determined by one of ordinary skill in the art, considering the measurement in question and the error associated with measurement of the particular quantity (e.g., the limitations of the measurement system).

Also, any numerical range recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Example embodiments of the present disclosure will now be described with reference to the accompanying drawings. In the drawings, the same or similar reference numerals refer to the same or similar elements throughout. As utilized herein, the utilize of the term “may,” when describing embodiments of the present disclosure, refers to “one or more embodiments of the present disclosure.”

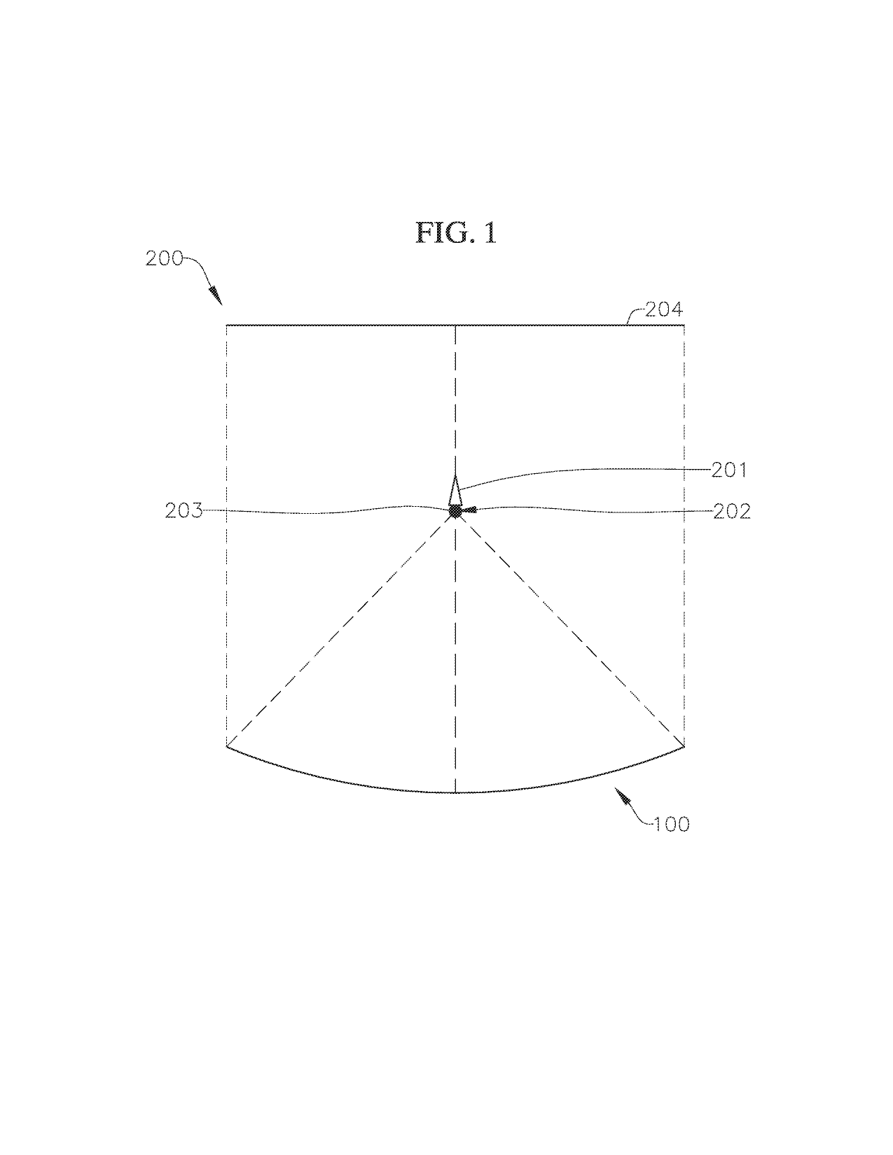

With reference now to FIG. 1, a parabolic reflector 100 according to one embodiment of the present disclosure may be incorporated into an antenna system 200 including a feed horn 201. In the illustrated embodiment, the feed horn 201 is positioned such that a phase center 202 (i.e., the point from which electromagnetic radiation is emitted) of the feed horn 201 is located at or substantially at a focal point 203 of the reflector 100. The feed horn 201 is configured to radiate electromagnetic energy which, once reflected by the reflector 100, forms a plane wave 204 that is directed away from the antenna system 200. As used herein, the terms “parabolic” and “parabaloidal” surfaces encompass surfaces which deviate from a true paraboloid but which are nevertheless intended to reflect and concentrate incident electromagnetic radiation. Further, when reference is made herein to “parabolic” curves, it will be understood to encompass curves which deviate from true parabolic curves but which are nevertheless intended to approximate curves on a paraboloidal surface and which are intended to reflect and concentrate incident electromagnetic radiation.

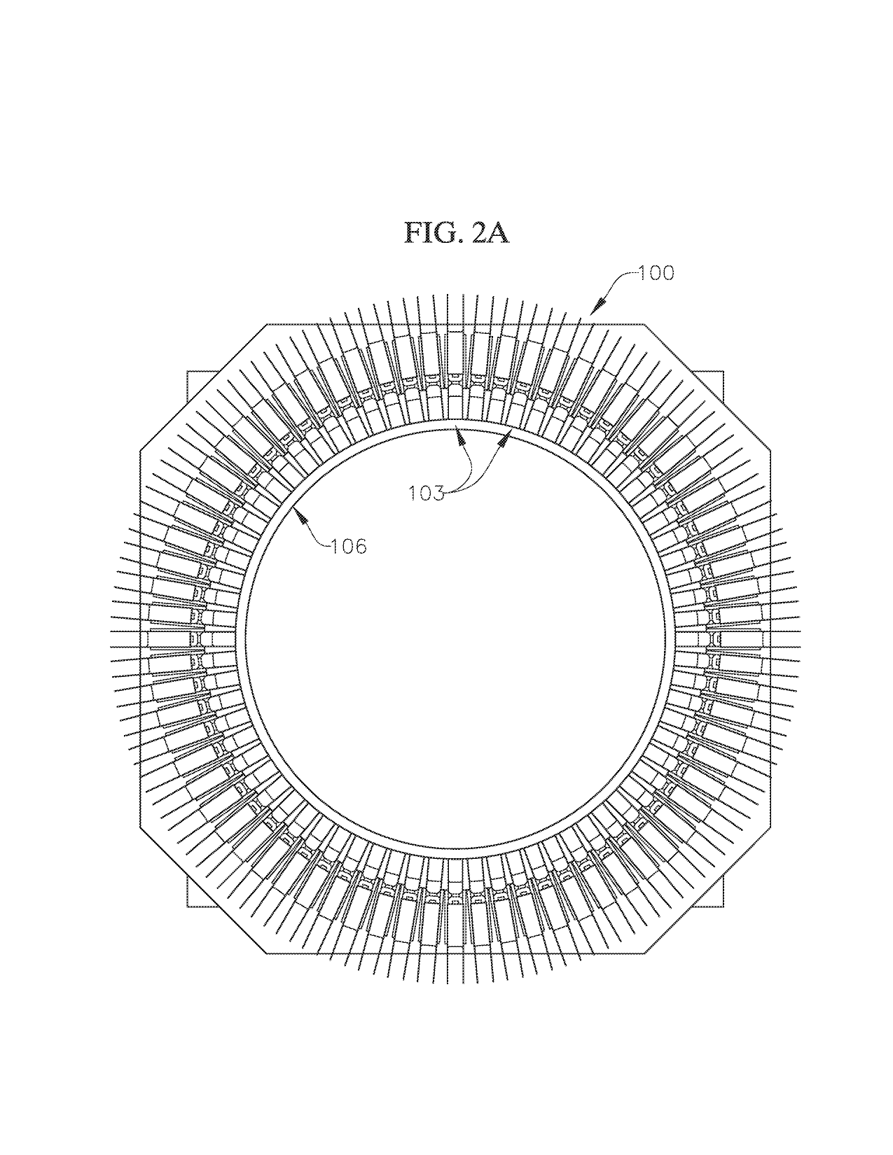

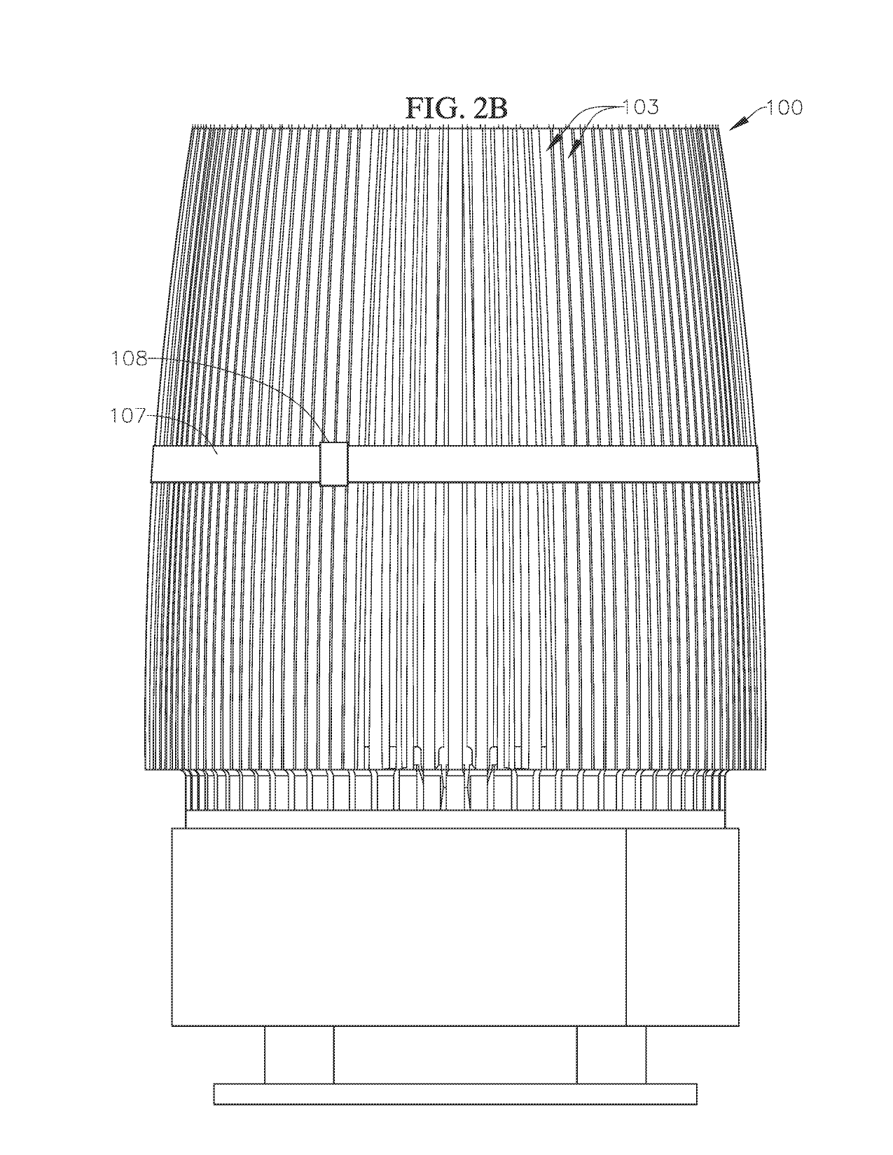

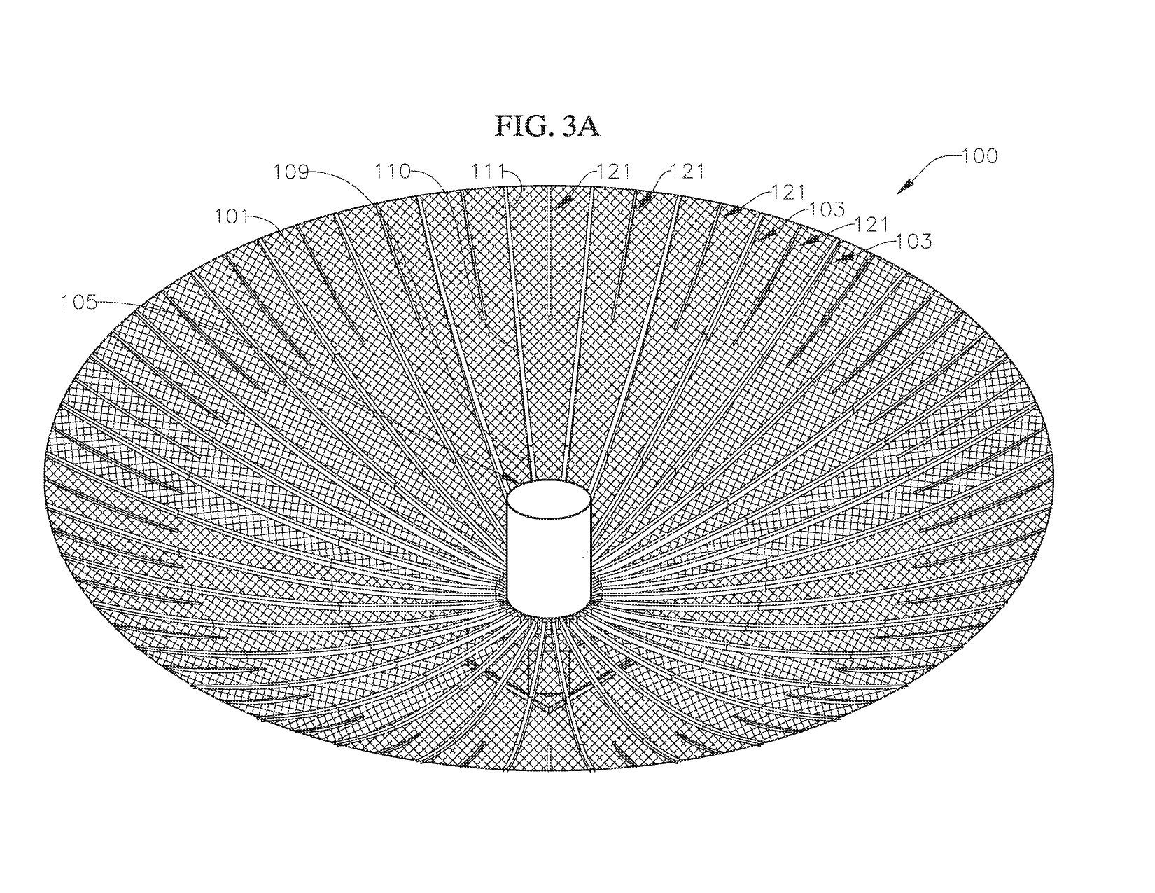

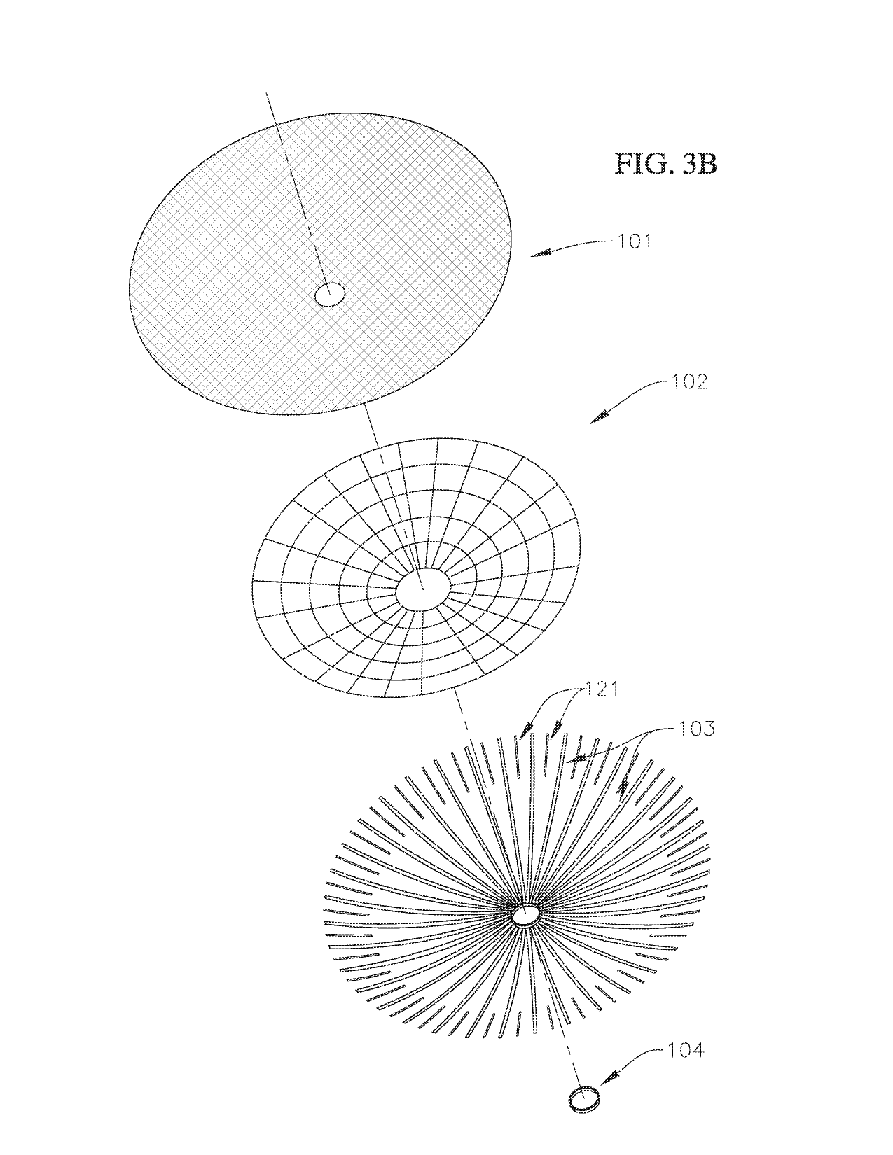

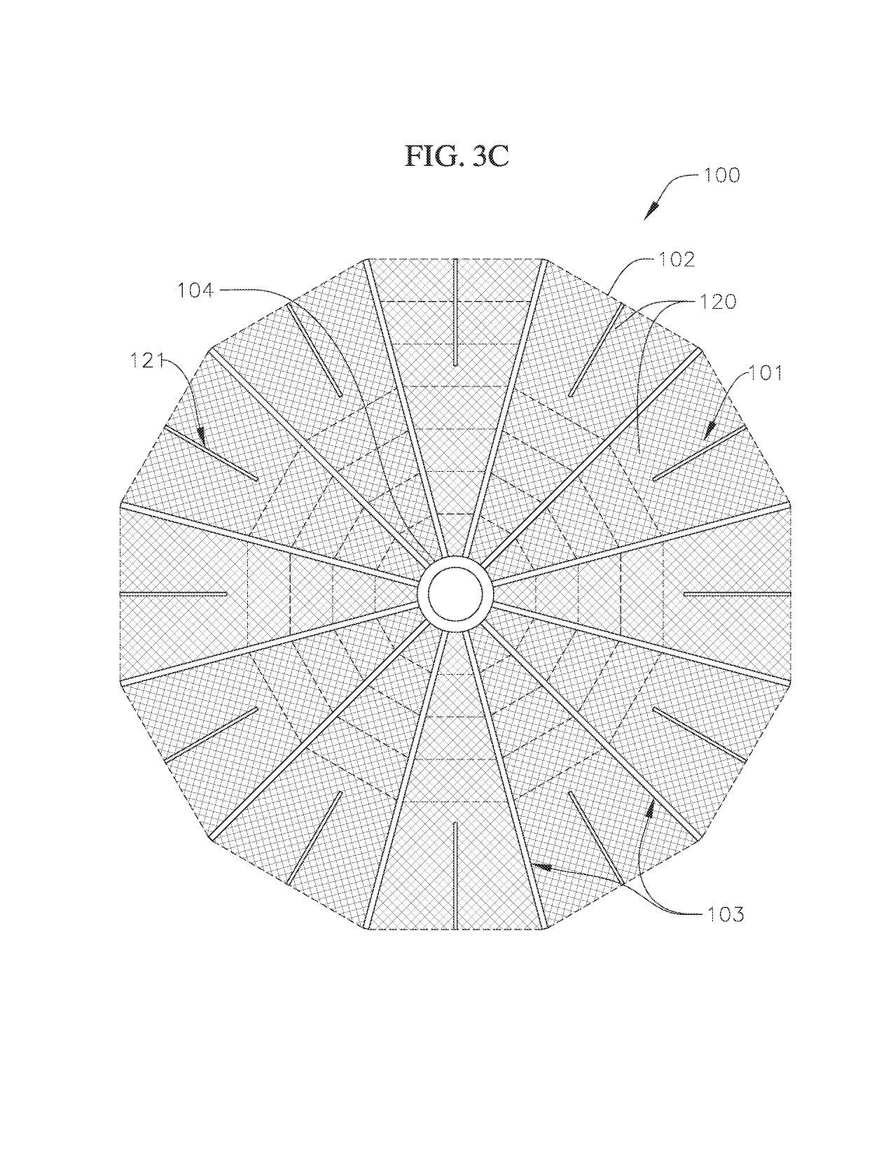

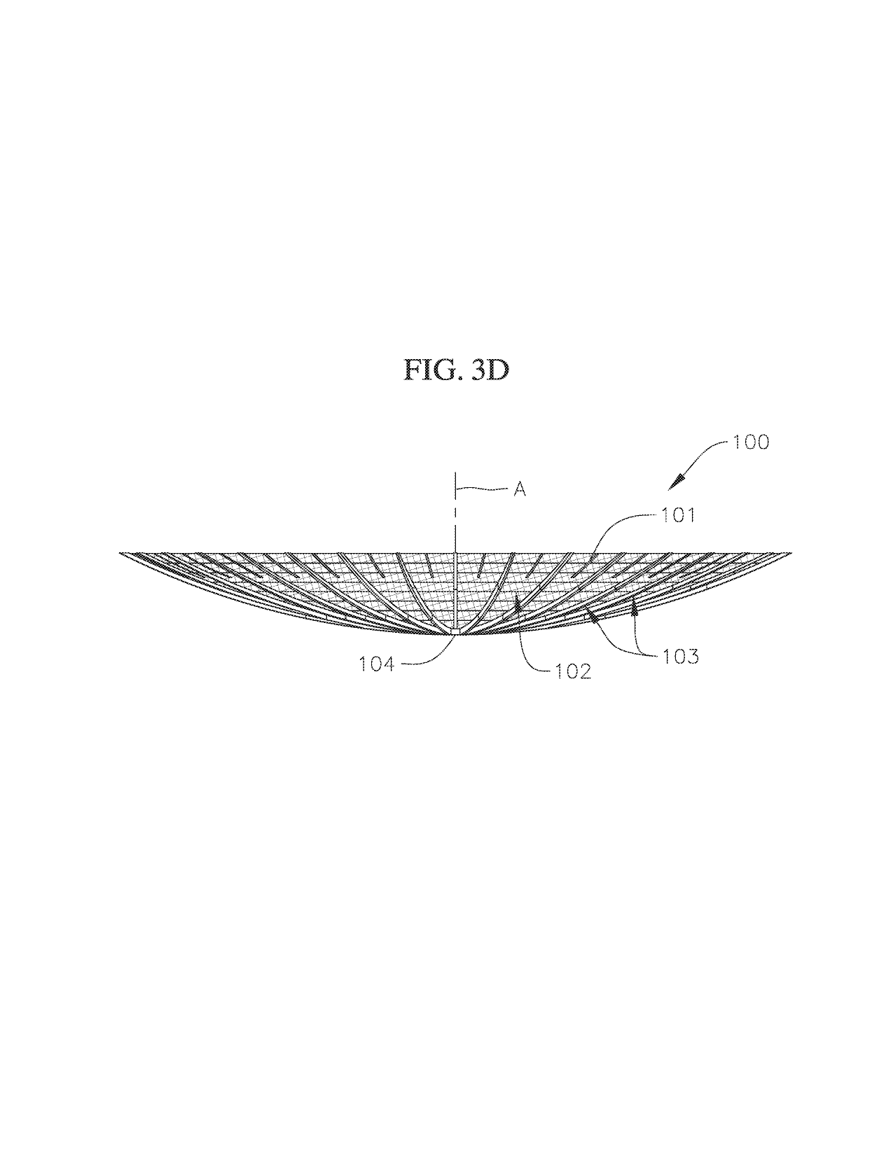

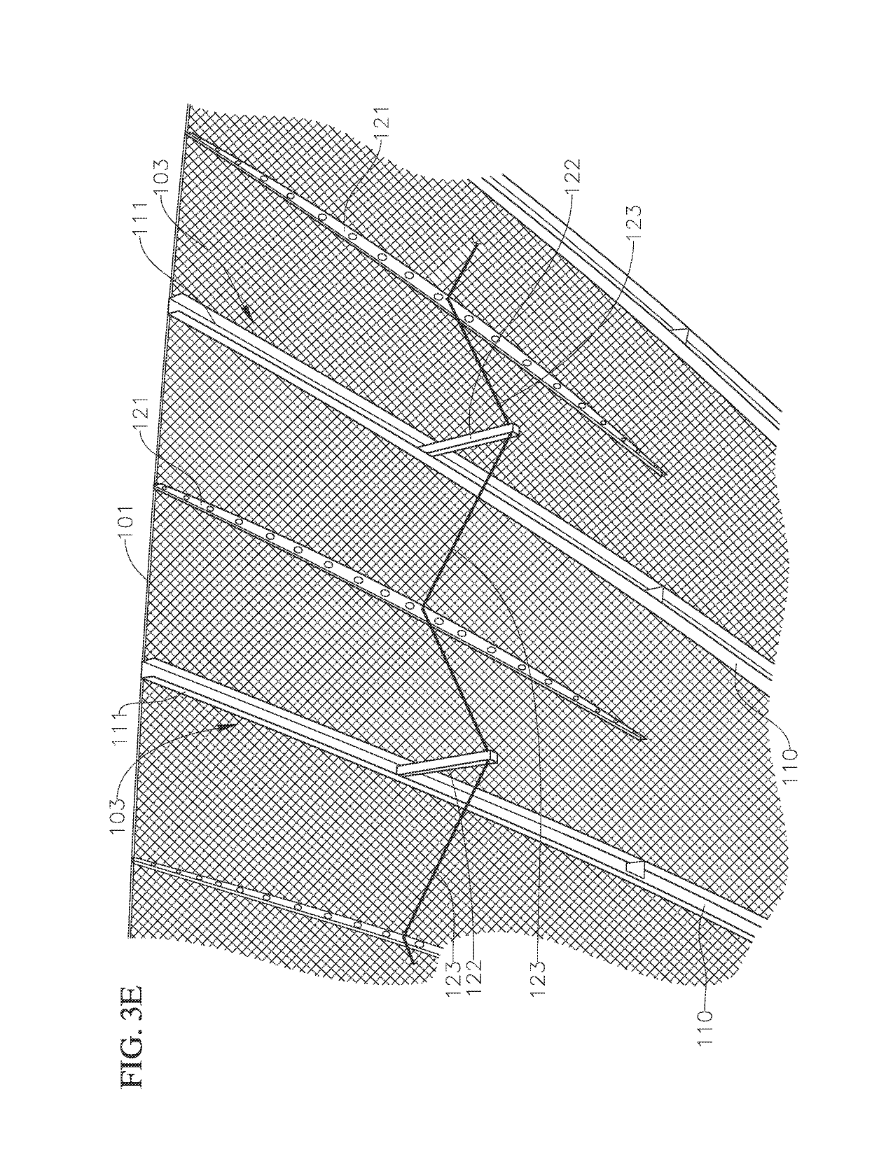

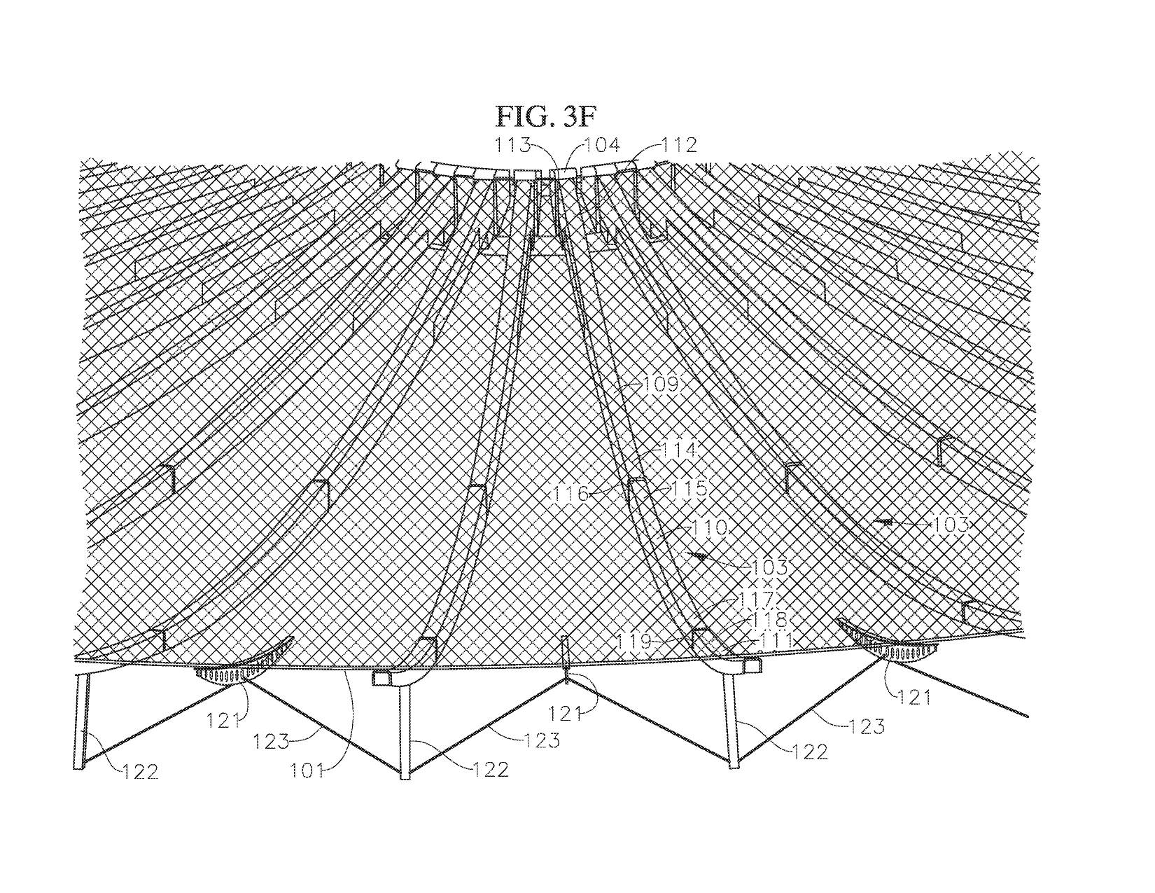

With reference now to the embodiment illustrated in FIGS. 2A-3F, the parabolic reflector 100 includes a flexible reflective material 101, a flexible net 102 (or other intermediate flexible interface), a plurality of ribs 103, and a central hub 104 defining a central axis A. In one or more embodiments, the flexible net 102 (or other intermediate flexible interface) may be coupled to the plurality of ribs 103 and/or the flexible reflective material 101. In one or more embodiments, the parabolic reflector 100 may not include the flexible net 102 (i.e., the flexible net 102 is optional). In the illustrated embodiment, the reflector 100 also includes a central structure 105 coupled to the central hub 104. Additionally, in the illustrated embodiment, the parabolic reflector 100 also includes launch locks 106 (e.g., one launch lock 106 for each rib 103) coupled to the central structure 105, a flexible restraining band 107 extending around an outer periphery of the ribs 103 in a stowed or collapsed configuration, and a hold down and release mechanism 108 (HDRM) coupled to the flexible restraining band 107. The flexible restraining band 107 is configured to maintain the parabolic reflector 100 in the stowed configuration (e.g., during launch) and actuation of the HDRM 108 is configured to release the flexible restraining band 107 and thereby enable the parabolic reflector 100 to move into a deployed configuration, as illustrated in FIGS. 3A-3F. As used herein, the term “flexible” means pliant, or incapable of retaining any given shape when not subjected to tensile forces. In one or more embodiments, the flexible restraining band 107 may be a flexible cord, tape, or other material that can be bent, folded, coiled, etc. without breaking and can be made to follow a defined path free or substantially free of creases or wrinkles when placed under tension.

In one or more embodiments, the reflector 100 may include thirty-six (36) ribs 103, forty-eight (48) ribs 103, or sixty (60) ribs 103. In the illustrated embodiment, the ribs 103 are uniformly or substantially uniformly spaced around the central hub 104 (e.g., uniformly or substantially uniformly arranged around a circumference of the central hub 104). In one or more embodiments, the reflector 100 may include any other suitable number of ribs 103, depending, for instance, on the size of the reflector 100. In one or more embodiments, the number of ribs of the reflector 100 may be in a range from twenty-four (24) ribs 103 to seventy-two (72) ribs 103.

In the illustrated embodiment, each rib 103 includes a root rib segment 109 rotatably coupled to the central hub 104, an intermediate rib segment 110 rotatably coupled to the root rib segment 109, and a tip rib segment 111 rotatably coupled to the intermediate rib segment 110. In the illustrated embodiment, a proximal end 112 of the root rib segment 109 is hingedly coupled to the central hub 104 by a first hinge 113, a distal end 114 of the root rib segment 109 opposite the proximal end 112 of the root rib segment 109 is hingedly coupled to a proximal end 115 of the intermediate rib segment 110 by a second hinge 116, and a distal end 117 of the intermediate rib segment 110 opposite to the proximal end 115 of the intermediate rib segment 110 is hingedly coupled to a proximal end 118 of the tip rib segment 111 by a third hinge 119 (e.g., each rib 103 includes three sections or segments 109, 110, 111 rotatably coupled together by precision hinges 113, 116, 119). In the illustrated embodiment, the root rib segment 109, the intermediate rib segment 110, and the tip rib segment 111 of each rib 103 each have a concave profile that follows or substantially follows a parabolic curve. When the root rib segment 109, the intermediate rib segment 110, and the tip rib segment 111 are arranged in the deployed configuration (as illustrated in FIGS. 3C the concave profile of each rib 103 lies predominantly or substantially predominantly on a single parabolic curve.

The configuration of the flexible net 102, the ribs 103, the central hub 104, the central structure 105, the launch lock 106, the flexible restraining band 107, and the HDRM 108 may be the same as or similar to the corresponding structures described in U.S. Patent No. 10,847,893, the entire content of which is incorporated herein by reference.

With reference now to FIGS. 3A-3F, the flexible reflective material 101 is divided or segmented into a plurality of facets 120. Each facet 120 of the flexible reflective material 101 extends between a pair of adjacent ribs 103 and has a generally triangular or wedge shape. In the illustrated embodiment, the parabolic reflector 100 also includes a plurality of facet breakers 121 coupled to the facets 120 of the flexible reflective material 101, a plurality of tensioner elements 122 coupled to the plurality of ribs 103, and at least one tensile element 123 coupling the plurality of tensioner elements 122 to the plurality of facet breakers 121. In the illustrated embodiment, a single facet breaker 121 is coupled to each of the plurality of facets 120 of the flexible reflective material 101, although in one or more embodiments two or more facet breakers 121 may be coupled to one or more of the facets 120 of the flexible reflective material 101 and/or one or more of the facets 120 may not be provided with any facet breakers 121.

In one or more embodiments, the plurality of tensioner elements 122 is coupled to the tip rib segments 111 of the ribs 103. In one or more embodiments, the plurality of tensioner elements 122 may be coupled to the intermediate rib segments 110 of the ribs 103. Each of the plurality of tensioner elements 122 is configured to move (e.g., rotate) between a stowed (retracted) position and a deployed position. In one or more embodiments, in the stowed position, the tensioner element 122 is at least partially housed within one of the ribs 103 (e.g., in the stowed position, each of the tensioner elements 122 is housed or accommodated within a slot or recess within one of the tip segments 111 or one of the intermediate rib segments 110 of the rib 103). In one or more embodiments, in the deployed position, the tensioner element 122 extends outward from the rib 103 (e.g., in the deployed position, the tensioner element 122 extends perpendicular or substantially perpendicular to the rib 103). In one or more embodiments, each of the tensioner elements 122 may be a rod or a bar (e.g., a bar having a generally square cross-sectional shape or a rod having a circular cross-sectional shape).

In the illustrated embodiment, each facet breaker 121 is coupled to the tensioner elements 122 on the adjacent ribs 103 that are connected to the facet 120 on which the facet breaker 121 is located (e.g., each facet breaker 121 is coupled on one side to one tensioner element 122 on one of the ribs 103 and on an opposite side to another tensioner element 122 on an adjacent rib 103). In one or more embodiments, the tensile element 123 may be a continuous tensile element that extends through an opening in each of the tensioner elements 122 and is coupled to each of the facet breakers 121. In one or more embodiments, the tensile element 123 may include a plurality of discrete tensile segments (e.g., the tensile element 123 may include a plurality of discrete tensile segments and each tensile segment may connect one tensioner element 122 to one facet breaker 121).

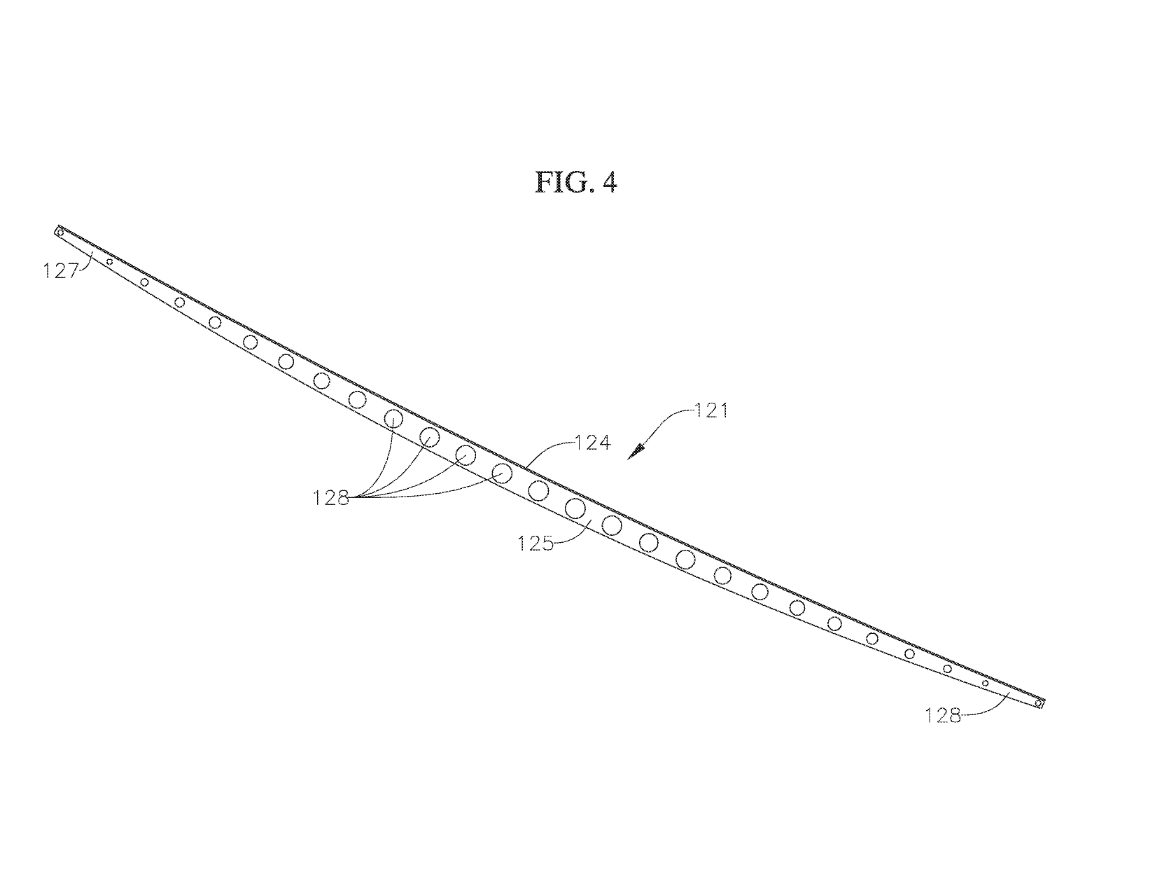

With reference now to the embodiment illustrated in FIG. 4, each of the facet breakers 121 is a secondary rib having a curved upper surface 124 following a parabolic or substantially parabolic profile. In one or more embodiments, each of the facet breakers 121 is shorter than the ribs 103. For instance, in one or more embodiments, each of the facet breakers 121 may have a length in a range from approximately 25% to approximately 50% of the length of the ribs 103 (i.e., each of the facet breakers 121 may have a length in a range from approximately 25% to approximately 50% of the combined length of the tip rib segment 111, the intermediate rib segment 110, and the root rib segment 109). In the illustrated embodiment, the outermost ends of the facet breakers 121 aligned or substantially aligned with the outermost ends of the ribs 103 (i.e., the outermost ends of the tip rib segments 111) along a circular periphery of the flexible reflective material 101. In one or more embodiments, the outermost ends of the facet breakers 121 may be spaced inward with respect to the outermost ends of the ribs 103 and the periphery of the flexible reflective material 101. Providing the facet breakers 121 at or proximate to the extent of the parabolic reflector 100, and not at or proximate to the hub 104, is configured to provide local parabolic shaping of the flexible reflective material 101 only where it is needed due to the increased gap between adjacent ribs 103 at the extent. That is, the flexible reflective material 101 tends to deviate from a parabolic shape only at (or at least to the greatest extent at) the extent of the flexible reflective material 101 where the spacing between adjacent ribs 103 is the greatest, and in one or more embodiments, the facet breakers 121 may be provided only in this region where the flexible reflective material 101 tends to deviate from a parabolic shape.

In the illustrated embodiment, each of the facet breakers 121 tapers at its distal and proximal ends (e.g., the facet breaker 121 tapers from a thickest intermediate portion 125 toward a thinner portion at the distal end 126, and from the intermediate portion 125 toward a thinner portion at the proximal end 127). Additionally, in one or more embodiments, each of the facet breakers 121 includes a plurality of openings 128 (e.g., holes having varying diameters along the length of the facet breaker 121) that reduce the overall mass of the facet breakers 121.

In the deployed position, the tensioner elements 122 and the tensile element(s) 123 pull the facet breakers 121 outward, which in turn tensions the flexible reflective material 101 between the plurality of ribs 103 (i.e., together, the tensioner elements 122, the tensile element(s) 123, and the facet breakers 121 tension the facets 120 of the flexible reflective material 101). Tensioning the flexible reflective material 101 between the ribs 103 is configured to improve the approximation of a paraboloidal surface section formed by the flexible reflective material 101 and thereby improve the gain, directivity, and efficiency of any antenna system employing the reflector 100. Moreover, the tensioner elements 122, the tensile element(s) 123, and the facet breakers 121 are configured to tension the facets 120 of the flexible reflective material 101 without adding additional ribs 103 and thus without adding the associated additional mass. That is, because the facet breakers 121 are lighter than the ribs 103 (e.g., due at least in part to the facet breakers 121 being shorter than the ribs 103), the facet breakers 121 are configured to tension the facets of the flexible reflective material 101 without adding the additional mass associated with increasing the number of ribs of the reflector 100.

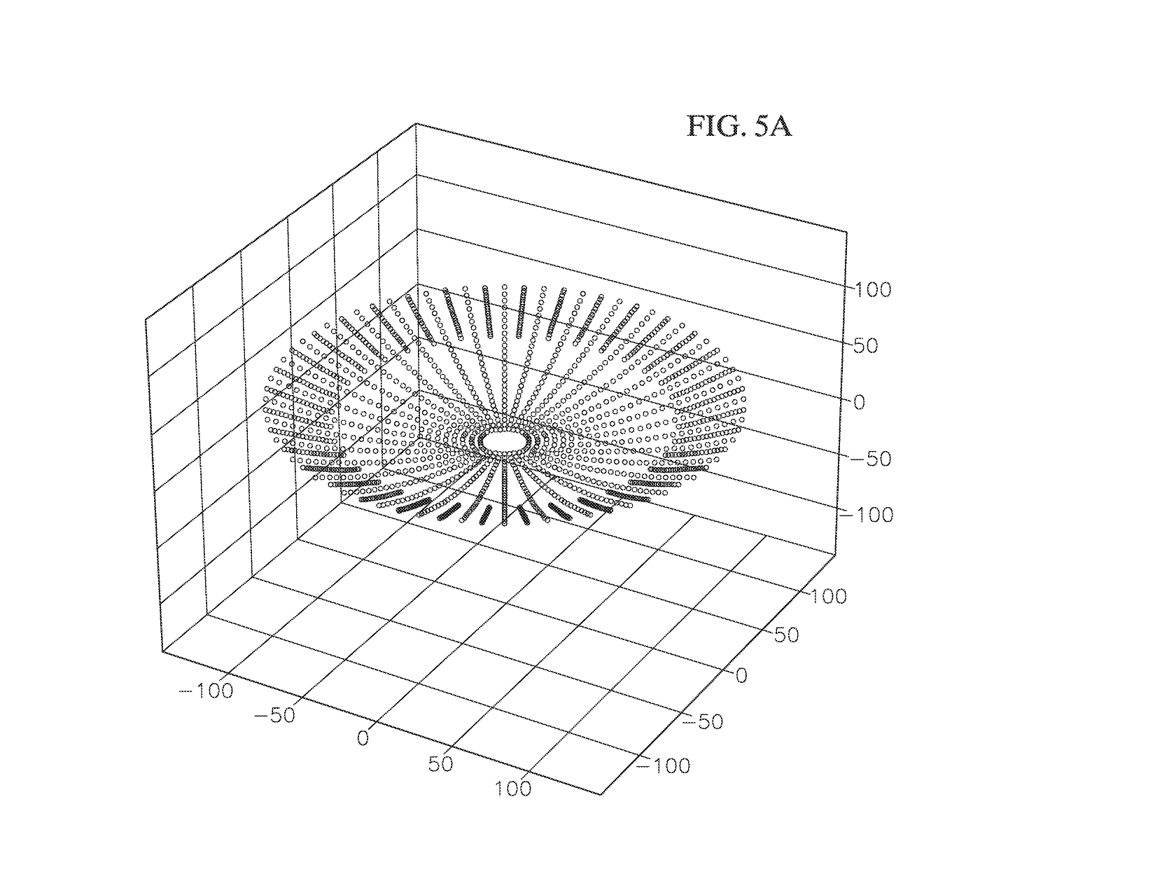

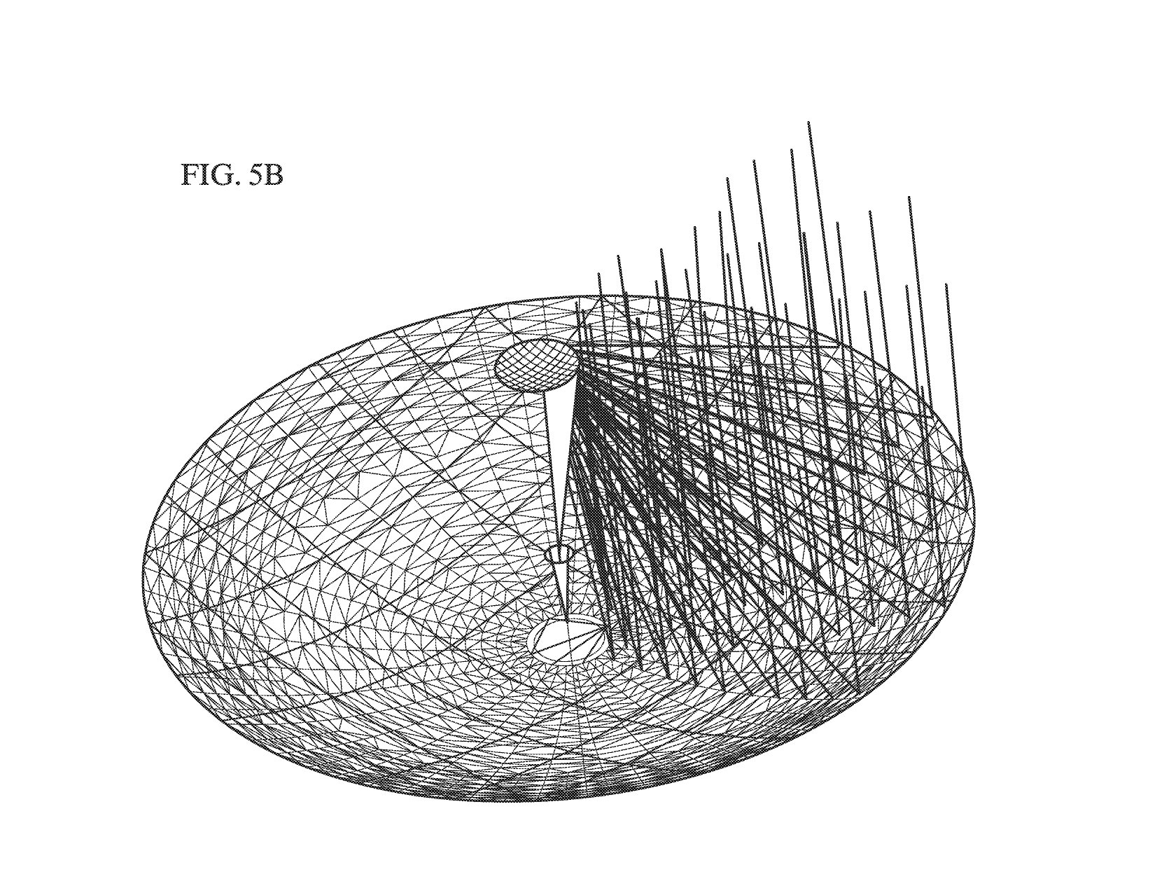

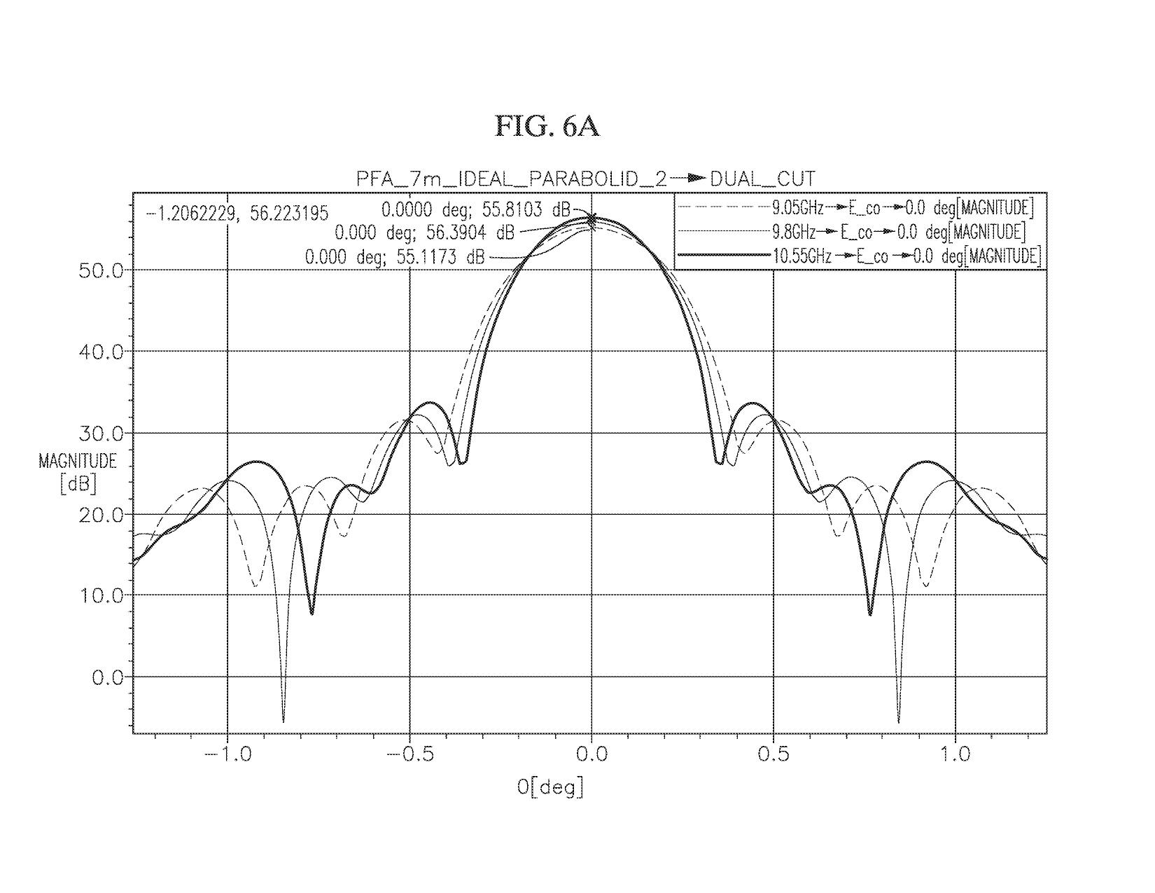

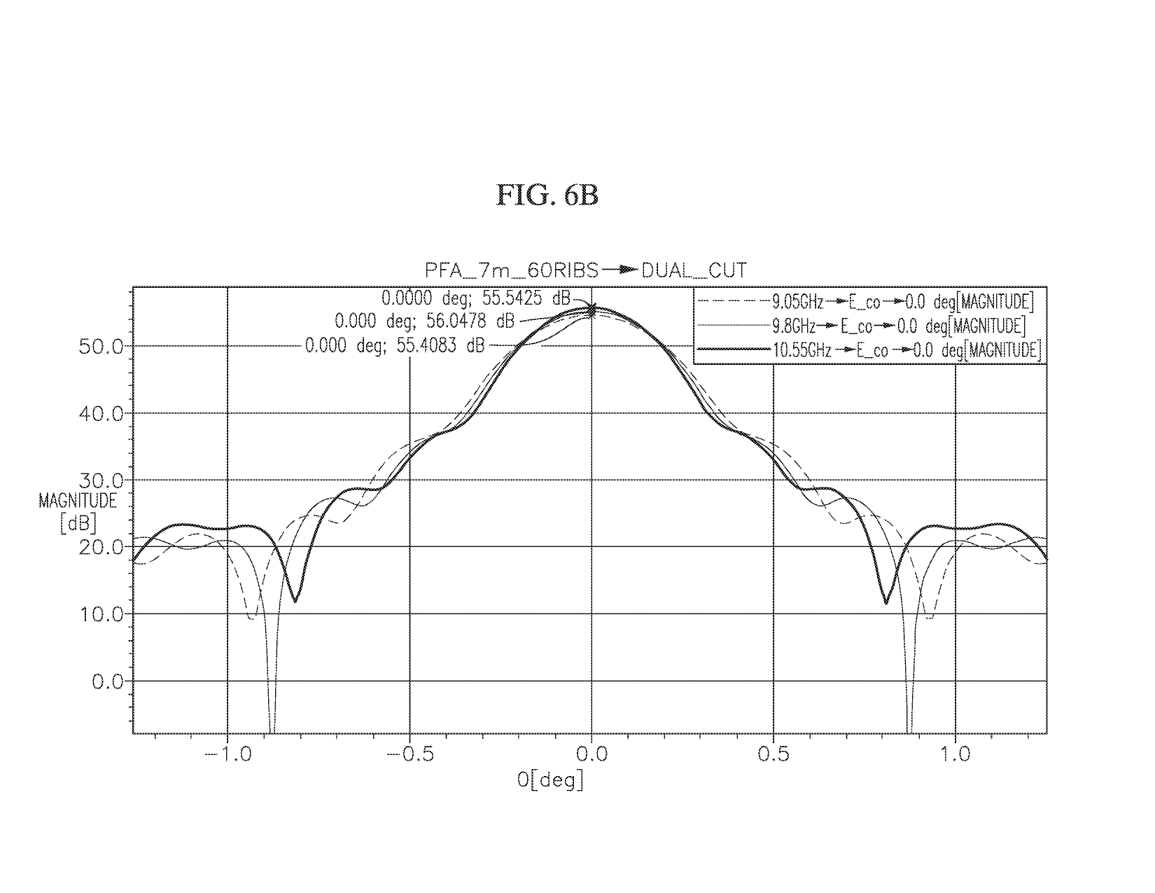

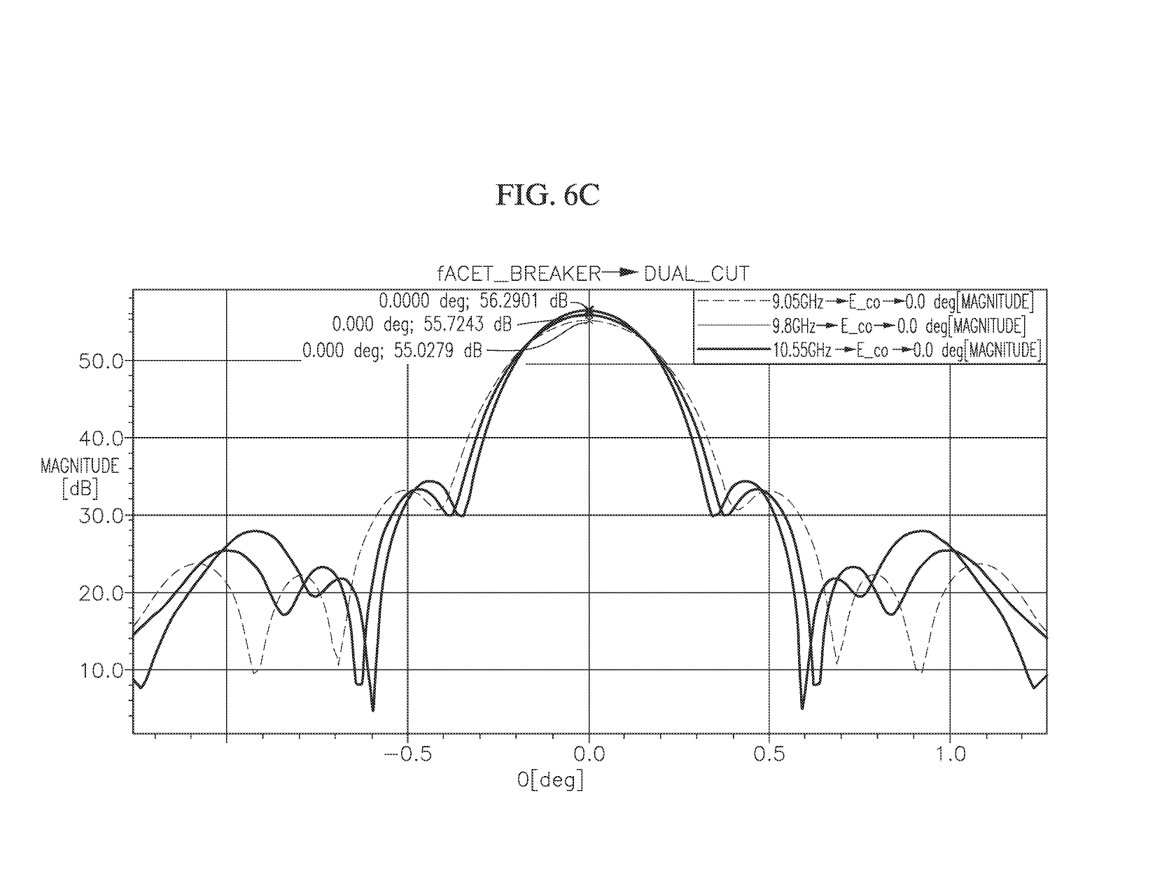

FIGS. 5A-5B are plots depicting a radiation pattern reflecting off a reflector according to one embodiment of the present disclosure. FIG. 6A is a graph depicting a signal (magnitude (dB) as a function of degree (θ)) reflected off a reflector having an ideal paraboloid shape. Accordingly, FIG. 6A depicts an ideal signal reflected off a reflector. FIG. 6B is a graph depicting a signal (magnitude (dB) as a function of degree (θ)) reflected off a related art reflector having sixty (60) ribs and no facet breakers between the ribs. FIG. 6C is a graph depicting a signal (magnitude (dB) as a function of degree (θ)) reflected off a reflector according to one embodiment of the present disclosure having forty-eight (48) ribs and facet breakers between adjacent ribs. As illustrated in FIGS. 6B-6C, the signal reflected off of the reflector having forty-eight ribs and the facet breakers (FIG. 6C) is closer than the signal reflected off the reflector having sixty ribs and no facet breakers (FIG. 6B) to the idealized signal shown in FIG. 6A. Accordingly, in one or more embodiments, the reflector having fewer ribs and facet breakers is configured to outperform the reflector having more ribs and no facet breakers, and also has less mass.

Although some embodiments of the present disclosure have been disclosed herein, the present disclosure is not limited thereto, and the scope of the present disclosure is defined by the appended claims and equivalents thereof.

What is claimed:

1. A reflector assembly comprising:
a central hub;
a plurality of ribs coupled to the central hub, the plurality of ribs being configured to move between a stowed configuration and a deployed configuration;
a plurality of tensioner elements coupled to the plurality of ribs, the plurality of tensioner elements being configured to move between a stowed configuration and a deployed configuration;
a flexible reflective material attached to the plurality of ribs, the flexible reflective material comprising a plurality of facets, each facet of the plurality of facets being between two adjacent ribs of the plurality of ribs;
a plurality of facet breakers connected to the plurality of facets of the flexible reflective material; and
at least one tensile element coupling the plurality of tensioner elements to the plurality of facet breakers,
wherein a first facet breaker of the plurality of facet breakers is connected to a first facet of the plurality of facets,
wherein a first tensioner element of the plurality of tensioner elements is coupled to a first rib of the plurality of ribs and to the first facet breaker of the plurality of facet breakers, and
wherein a second tensioner element of the plurality of tensioner elements is coupled to a second rib of the plurality of ribs and to the first facet breaker.

2. The reflector assembly of claim 1, wherein the first facet breaker is substantially centered between the first rib and the second rib.

3. The reflector assembly of claim 2, wherein the first facet breaker is substantially oriented radially toward the central hub when the reflector assembly is in a deployed configuration.

4. The reflector assembly of claim 1, wherein the first facet breaker is shorter than each of the first rib and the second rib.

5. The reflector assembly of claim 4, wherein the first facet breaker has a length in a range from approximately 25% to approximately 50% of a length of each of the first rib and the second rib.

6. The reflector assembly of claim 1, wherein each rib of the plurality of ribs comprises:
a root rib segment rotatably coupled to the central hub by a first hinge;
at least one intermediate rib segment having a proximal end rotatably coupled to a distal end of the root rib segment by a second hinge; and
a tip rib segment having a proximal end rotatably coupled to a distal end of the at least one intermediate rib segment by a third hinge.

7. The reflector assembly of claim 6, wherein:
the root rib segment is configured to rotate in a first direction about a first axis away from a central axis of the central hub as the reflector assembly moves into the deployed configuration,
the at least one intermediate rib segment is configured to rotate in the first direction about a second axis substantially parallel to the first axis as the reflector assembly moves into the deployed configuration, and
the tip rib segment is configured to rotate in the first direction about a third axis substantially parallel to the second axis as the reflector assembly moves into the deployed configuration.

8. The reflector assembly of claim 7, wherein each of the plurality of tensioner elements is configured to rotate about a fourth axis substantially parallel to the third axis as the reflector assembly moves into the deployed configuration.

9. The reflector assembly of claim 1, wherein each of the plurality of facet breakers is a secondary rib having a curved upper surface following a substantially parabolic profile.

10. The reflector assembly of claim 9, wherein the secondary rib comprises a plurality of openings which reduce mass.

11. The reflector assembly of claim 10, wherein the secondary rib tapers from a thickest intermediate portion toward a thinner distal end, and from the thickest intermediate portion toward a thinner proximal end.

12. The reflector assembly of claim 1, wherein the at least one tensile element is a single continuous tensile element.

13. The reflector assembly of claim 1, wherein the at least one tensile element comprises a plurality of discrete tensile segments.

14. The reflector assembly of claim 1, wherein the flexible reflective material, the plurality of ribs, and the plurality of facet breakers together form a reflective surface with a substantially paraboloidal surface profile configured to focus electromagnetic energy when the reflector assembly is in a deployed configuration.

15. The reflector assembly of claim 1, further comprising a flexible net coupled to the flexible reflective material.

16. The reflector assembly of claim 1, wherein the plurality of ribs is in a range from twenty-four to seventy-two ribs.

17. A method of operating a deployable reflector assembly comprising a central hub, a plurality of ribs coupled to the central hub, a flexible reflective material attached to the plurality of ribs, a plurality of facet breakers coupled to the flexible reflective material, a plurality of tensioner elements coupled to the plurality of ribs, and at least one tensile element coupling the plurality of tensioner elements to the plurality of facet breakers, the method comprising:
moving each of the plurality of ribs from a stowed configuration to a deployed configuration, and
moving each of the plurality of tensioner elements from a stowed configuration to a deployed configuration.

18. The method of claim 17, wherein each rib of the plurality of ribs comprises a root rib segment rotatably coupled to the central hub, an intermediate rib segment rotatably coupled to the root rib segment, and a tip rib segment rotatably coupled to the intermediate rib segment, and
wherein the moving the plurality of ribs from the stowed configuration to the deployed configuration comprises:
rotating, in a first direction away from a central axis of the central hub, the root rib segment of each rib of the plurality of ribs relative to the central hub;
rotating, in the first direction, the intermediate rib segment of each rib of the plurality of ribs relative to the root rib segment after the rotating of the root rib segment; and
rotating, in the first direction, the tip rib segment of each rib of the plurality of ribs relative to the intermediate rib segment after the rotating of the intermediate rib segment.
